(19) United States
(12) Patent Application Publication
(10) Pub. No.: US 2026/0347156 A1
(43) Pub. Date: Nov. 5, 2026

(54) HOIST BLOCK SYSTEM, HOISTING ASSEMBLY, VESSEL OR BARGE, AND METHOD

(71) Applicant: GustoMSC B.V., Schiedam (NL)

(72) Inventors: Steven Franciscus SLOOT, Spijkenisse (NL); Wilhelmus Coenradus Johannes Jozephus WOLDRING, Rotterdam (NL)

(21) Appl. No.: 19/118,836

(22) PCT Filed: Oct. 18, 2023
(86) PCT No.: PCT/EP2023/079041

§ 371 Date: Apr. 7, 2025

(30) Foreign Application Priority Data
Oct. 18, 2023 (NL) 2033352

(51) Int. Cl. B66D 3/08; B66C 23/52

(52) U.S. Cl. CPC B66D 3/08; B66C 23/52

(57) ABSTRACT

Hoist block system for hoisting a hoist load selectively using fewer or more falls of a hoist reeving, wherein an upper block assembly is configured to block upward movement of suspended second lower block sheave assemblies towards the upper block assembly, while allowing upward movement of suspended first lower block sheave assemblies with a connected lower block base towards the upper block assembly, so that the second lower block sheave assemblies can be unloaded by pulling the first lower block sheave assemblies with the connected lower block base up towards the upper block assembly beyond a predetermined limit, wherein the unloaded second lower block sheave assemblies are disconnectable from the lower block base, to thereby reduce the number of falls by which the lower block base is suspended from the upper block assembly.

### FIELD

The invention relates to a hoist block system for hoisting a hoist load selectively using fewer or more falls of a hoist reeving. The invention further relates to: a hoisting assembly comprising the hoist block system; a vessel or barge provided with the hoisting assembly; and a method of adjusting an effective number of falls in the hoisting assembly.

### BACKGROUND

Hoist block systems for hoisting a hoist load selectively using fewer or more falls of a hoist reeving are known as such, in particular in the form of so-called ‘splittable blocks’, referring to the notion that one or more sheave parts of a hoist block system can be separated or ‘split off’ from a lower main part of the hoist block system so that respective falls can effectively be disabled if desired. Such split-off sheave parts may then be parked at a high level, e.g. at a so called upper block of the system, while the hoist reeving can remain, i.e. no reeving out is needed. Subsequently, the disabled falls can be enabled again by rejoining the split-off parts with the lower main part. Thereby, loads can be hoisted selectively using fewer or more falls of a hoist reeving which can itself remain unaltered throughout the hoisting operations. Such selectivity can be beneficial since fewer falls generally enable higher hoisting speeds and larger vertical hoisting ranges, while more falls generally enable larger hoist loads. So, depending on the characteristics of the specific hoisting operation, a hoisting crew may decide to use fewer or more falls, without having to change the reeving of the hoist reeving. Such a practice is known i.a. in offshore hoisting operations, where a hoist block system may be suspended by a hoist reeving from a hoist arm, e.g. of a crane, mounted e.g. on a vessel.

Known hoist block systems can be split and rejoined when supported on a dedicated platform or cradle, sometimes called a ‘basket’, e.g. on a deck of the vessel, so that the weight of the hoist block system can be unloaded from the hoist reeving and the hoist block system is stabilized and made accessible for crew to effect the necessary mechanical adjustments.

There is an ongoing need to make offshore hoisting operations more efficient and versatile, in particular while maintaining or improving reliability, durability and safety. In particular, there is a need to enable higher hoisting levels without corresponding increases in vessel size and while maintaining or improving efficiency, for example in the context of offshore wind turbine installation and maintenance.

### SUMMARY

An object of the invention is to address one or more of the above mentioned needs. An object is to provide a hoist block system, in particular for offshore hoisting operations, in which the effective number of falls can be adjusted more easily, more quickly and/or under a wider range of conditions. An object is to at least provide an alternative hoist block system and/or hoisting assembly.

Thereto, an aspect of the invention provides a hoist block system for hoisting a hoist load selectively using fewer or more falls of a hoist reeving. The hoist block system comprises: an upper block assembly comprising a plurality of interconnected upper block sheaves configured to support the falls; and a lower block subsystem. The lower block subsystem comprises: a lower block base configured to have the hoist load suspended therefrom; and a plurality of lower block sheave assemblies. The lower block sheave assemblies are each connectable to the lower block base and each comprise a lower block sheave suspendible from the upper block sheaves by some of the falls. The plurality of lower block sheave assemblies include one or more first lower block sheave assemblies and one or more second lower block sheave assemblies.

The upper block assembly is configured to block upward movement of the suspended second lower block sheave assemblies towards the upper block assembly, while allowing upward movement of the suspended first lower block sheave assemblies with the connected lower block base towards the upper block assembly, when the first and second lower block sheave assemblies are connected to the lower block base and are pulled up towards the upper block assembly by shortening of the falls, so that the second lower block sheave assemblies can be unloaded by pulling the first lower block sheave assemblies with the connected lower block base up towards the upper block assembly beyond a predetermined limit.

The unloaded second lower block sheave assemblies are disconnectable from the lower block base, to thereby reduce the number of falls by which the lower block base is suspended from the upper block assembly.

Advantageously, in order to use fewer or more falls, the hoist block system thus does not need to be received in a so-called ‘basket’on deck.

Instead, to use fewer falls, the second lower block sheave assemblies can be disconnected while the hoist block system is suspended from a hoist arm, such as a boom or an A-frame, e.g. in a crane. To use more falls, the second lower block sheave assemblies can be reconnected, essentially by reversing the steps used for the disconnection, again without having to lower the hoist block system or any part thereof into a basket or the-like. Such connection and disconnection during suspension is not utilized in conventional hoist block assemblies, in which there is typically no differentiation among lower block sheave assemblies regarding how far each sheave assembly can be pulled up towards the upper block assembly. In a hoist block system according to the invention, such differentiation advantageously enables selective unloading of lower block sheave assemblies, in particular unloading of the second lower block sheave assemblies, while the first lower block sheave assemblies remain loaded, thereby also providing continued suspension of the connected lower block base. Moreover, such selective unloading can make the disconnecting and subsequent reconnecting of the second lower block sheave assemblies less labor intensive, in particular compared to traditional methods in which disconnection and reconnection involves hammering while the hoist block system is received in the basket. The disconnecting and/or reconnecting can even be partly or fully automated, e.g. using a motor, as explained further elsewhere herein.

It shall be appreciated that in the present context, the expression that a second lower block sheave assembly is unloaded can be understood as that external weight is removed from said sheave assembly, in particular a weight of the lower block base, so that disconnection of the second lower block sheave assembly from the lower block base is possible without the weight of the lower block base causing friction or shock during the disconnecting process. Such unloading is here essentially achieved by raising the lower block base with respect to the second lower block sheave assemblies, which in turn is enabled essentially by the differences in how far the first and second lower block sheave assemblies can be pulled up towards the upper block assembly before being blocked thereby.

It shall be appreciated that such a difference in how far lower block sheave assemblies can be pulled up can be realized in various ways. In some embodiments, upper block engagement faces of the second lower block sheave assemblies are at a higher level than such engagement faces of the first lower block sheave assemblies, while a blocking member of the upper block assembly is configured to engage the engagement faces of the lower block sheave assemblies all at a same level. Alternatively, the engagement faces of the lower block sheave assemblies could be all at a same level, while the blocking member is configured to engage the engagement faces at different levels for different types of lower block sheave assemblies. Further variations are possible, for example wherein both the blocking member and the engagement faces are configured to contribute to the differentiation. Also, instead of a single blocking member, different blocking members could be provided for different lower block sheave assemblies, e.g. at different levels. It follows that the aforementioned predetermined limit can be realized in various ways, but can be generally interpreted as a vertical limit relative to the upper block assembly, which limit is upwardly traversable by the first lower block sheave assemblies, while similar upward movement of the second lower block sheave assemblies with respect to the upper block assembly is blocked by the upper block assembly.

Thus, by a relatively simple structural differentiation in the hoist block system, it can be provided that the effective number of falls can be adjusted relatively easily and quickly, in particular without having to lower the hoist block system or parts thereof into a so-called basket.

Preferably, the upper block assembly is configured to block upward movement of the suspended first lower block sheave assemblies towards the upper block assembly beyond a further predetermined limit closer to the upper block assembly than the predetermined limit, the further predetermined limit for example being at a downward facing side of the upper block assembly. Straining of the second lower block sheave assemblies during their disconnection can advantageously be prevented thereby, in particular without requiring highly precise active positioning of the first lower block sheave assemblies, which would be difficult to achieve using only winches associated with the reeving. The distance between the predetermined limit and the further predetermined limit is preferably chosen in accordance with one or more dimensions in a connecting mechanism for the second lower block sheave assembly, in particular a dimension of available play therein, so that the connection between the second lower block sheave assembly and the lower block base can relatively easily be maintained substantially free of strain during disconnecting and/or reconnecting.

The disconnectability and reconnectability of the unloaded second block sheave assemblies with respect to the lower block base can be realized in various ways.

Preferably, the second lower block sheave assemblies are each connectable to the lower block base so as to be rotatable with respect to the lower block base about a respective swivel axis. Preferably, the first lower block sheave assemblies are similarly connectable to the lower block base.

Swiveling lower block sheave assemblies are known as such for promoting a robust suspension of the lower block subsystem, in particular to promote substantially equal rope tension for different sheaves and avoid so-called side lead, for example in case of unequal spooling in case multiple winches are used on a same hoist reeving. Such swiveling can be applied in the present hoist block system with corresponding advantages, thereby increasing ease of use and versatility of the hoist block system.

Preferably, the hoist block system comprises, for each of the second lower block sheave assemblies, and preferably for one or more of the first lower block sheave assemblies, a connecting mechanism, configured to provide the connectability and disconnectability of the respective lower block sheave assembly with respect to the lower block base.

Preferably, the connecting mechanism is further configured to provide the preferred rotatability of the respective lower block sheave assembly with respect to the lower block base about the respective swivel axis when connected. In that case, the connecting mechanism may also be denoted as a combined connecting and swiveling mechanism.

Thereby, a relatively light-weight and compact hoist block system can be provided in which the aforementioned functions of the swiveling and the connectability and disconnectability are structurally combined.

Nevertheless, in embodiments, the swiveling function may be omitted or may be realized separately from the connecting mechanism, e.g. for one, some or all of the lower block sheave assemblies.

Preferably, the connecting mechanism is comprised by, in particular fixed to, the lower block base.

In this way, the second lower block sheave assemblies can be relatively light-weight, which can be particularly advantageous while are disconnected from the lower block base and remain at a high level such as at the upper block assembly. It shall be appreciated that one or more interface related elements for such a mechanism, such as a bearing, may then nevertheless be comprised by the second upper block sheave assembly. Alternatively or additionally, such a connecting mechanism could be comprised by, in particular fixed to, the lower block sheave assembly, e.g. for one, some or all of the lower block sheave assemblies.

Preferably, the connecting mechanism comprises at least one shaft assembly comprising one or more shaft elements, e.g. aligned with the optional swivel axis, the shaft assembly being adjustable between a retracted state and an extended state, wherein in the extended state the shaft elements interconnect the respective lower block sheave assembly with the lower block base, wherein in the retracted state the shaft elements release the respective lower block sheave assembly with respect to the lower block base.

Such an adjustable shaft assembly can advantageously provide the aforementioned combination of connecting, disconnecting and swiveling functions, where such a combination is desired. In any case, such an adjustable shaft assembly can form and/or contribute to a relatively compact and effective connecting mechanism.

Preferably, in the extended state, each of the shaft elements extends through a corresponding shaft opening in the respective lower block sheave assembly and/or through a corresponding shaft opening in the lower block base, wherein, in the retracted state, the shaft element is outside at least one of said shaft openings, preferably at least outside the shaft opening of the lower block sheave assembly. In the present context, the term shaft opening may be interpreted as an opening through which the shaft element of the shaft assembly can extend to form a load bearing interface therebetween, the shaft opening not being part of the shaft assembly itself. Thus, for example, in case the shaft assembly comprises a shell in which the shaft element is movably received, an interior of said shell is not regarded as a shaft opening in the present context.

Thereby, the shaft assembly can provide the aforementioned connecting and disconnecting functions. In particular, when the shaft element is outside at least one of the shaft openings, the lower block sheave assembly may thereby be disconnected from the lower block base. In the extended state, the shaft element may extend through corresponding openings of the lower block sheave assembly and the lower block base to thereby link those elements, for example rotatably link those elements about the optional swiveling axis. Alternatively, the shaft element could extend through a shaft opening in only one of such elements, wherein the connection to the other element could be provided differently, e.g. being in the form of a cantilevered connection so that the shaft element can provide a cantilevered support. However, preferably, the shaft element provides a so called simple support in the extended state, in particular being connected to one of the elements, e.g. the lower block base, on two sides of the connection to the other element, e.g. the lower block sheave assembly.

Preferably, the shaft element and the corresponding shaft opening of the lower block sheave assembly are dimensioned and/or shaped to provide play therebetween when the shaft assembly is in the extended state, while also providing a substantially fitting interface therebetween along parts of the circumferences of the shaft element and shaft opening arranged to transmit loads therebetween during use.

In this way, the shaft element can be extended through and retracted from the shaft opening relatively easily, while still enabling well distributed load transfer therebetween when connected.

Preferably, a section of the shaft element extending in the shaft opening of the lower block sheave assembly when the shaft assembly is in the extended state, and said shaft opening itself, have mutually different cross sectional shapes, in particular with mutually corresponding radii only along a limited circumferential part including a part configured to provide a load bearing interface.

The aforementioned dimensioning and/or shaping to provide both play and well distributed load transfer can be realized thereby.

Preferably, a section of the shaft element extending in the shaft opening of the lower block sheave assembly when the shaft assembly is in the extended state, and/or said shaft opening itself, is provided with a bearing to reduce rotational friction between said shaft opening and the shaft element, in particular about the optional swivel axis, when the shaft assembly is in the extended state.

Smooth and durable swiveling can be provided thereby, if desired. In any case, wear can be prevented and a self-stabilizing interface can be provided thereby. Alternatively or additionally, such a bearing could be provided on the shaft element itself. In some case, such a bearing could be omitted, for example when swiveling is not desired. The shaft elements and corresponding shaft openings then also do not need to be shaped so as to be mutually rotatable about an axial direction of the shaft elements, and axes of shaft elements of a same shaft assembly then do not need to be mutually aligned.

Preferably, the hoist block system comprises at least one motor and/or gear box coupled, at least couplable, to the shaft element for adjusting the shaft assembly between the retracted state and the extended state by driving of the motor and/or gear box.

In case of a motor, the shaft assembly can be adjusted automatically and/or remotely, obviating the need for personnel to be present at the shaft assembly for the adjustment, so that the adjustment may be effected e.g. at a high level as opposed to e.g. on a deck level.

Alternatively, the adjustment could be driven by personnel, e.g. using a sling or other tool, e.g. from a platform near a tip of a boom from which the hoist block system is suspended. A gear box, e.g. between the motor and the shaft assembly, or between a tool and the shaft assembly, can provide a suitable and convenient transmission.

Preferably, multiple of the shaft elements are coupled to a same motor and/or gear box of the at least one motor and/or gear box, in particular for synchronized adjustment of the multiple shaft elements. between the retracted state and the extended state, wherein in particular said multiple shaft elements are comprised by a same shaft assembly and/or are for connection with a same lower block sheave assembly and/or are aligned with a same swivel axis. For example, a gear box could have a single input shaft drivable by a motor or tool and multiple output shafts coupled to respective shaft elements.

In this way, the hoist block system can be relatively compact, taking advantage of the notion that shaft elements for a same lower block sheave assembly generally need not be mutually independently operable.

Preferably, the motor and/or gear box is coupled to the shaft element via a conversion mechanism configured to convert a rotation of an output shaft of the motor to an axial translation of the shaft element.

Thereby, the shaft element may be adjusted by a translation along its axis, while the motor can be a rotary motor. A flexible coupling may be provided, e.g. as part of the conversion mechanism, so as to allow tolerance for possible small misalignments.

The first lower block sheave assemblies are preferably disconnectable from and subsequently reconnectable to the lower block base, e.g. when the lower block base is lowered into a basket or the-like for direct access by personnel. Thereby, the lower block base may be released from the lower block sheave assemblies if and when desired, e.g. during a relatively long transit and/or for maintenance. Connecting mechanisms may thereto be provided for the first lower block sheave assemblies, e.g. similar to the second lower block sheave assemblies. However, disconnection of the first lower block sheave assemblies from the lower block base is preferably only performed when the lower block base is stably supported e.g. in a basket, and is otherwise preferably actively and/or intrinsically inhibited to prevent that the lower block base would be accidentally released while being suspended.

Preferably, guiding structures, in particular centering structures, are provided in the hoist block system to guide mutual positioning of e.g.: the lower block sheave assemblies with respect to the blocking member of the upper block assembly; and/or the second lower block sheave assemblies, in particular a shaft opening thereof, with respect to the lower block base and/or the shaft assembly.

A further aspect provides a hoisting assembly for hoisting a hoist load selectively using fewer or more falls of a hoist reeving, comprising a hoist block system as described herein and the hoist reeving.

Such a hoisting assembly provides above mentioned advantages.

Preferably, the hoisting assembly comprises a hoist arm, such as a boom or an A-frame, wherein the hoist block system is suspended from the hoist arm, wherein the hoisting assembly preferably comprises one or more winches engaged with the hoist reeving for adjusting the lengths of the falls.

Thereby, the hoisting assembly and hoist block system may be used in a variety of hoisting operations.

A further aspect provides a vessel or barge provided with a hoisting assembly as described herein, in particular for offshore hoisting operations.

Such a vessel or barge provides above mentioned advantages.

A further aspect provides a method of adjusting an effective number of falls in a hoisting assembly. The method comprises providing a hoisting assembly as described herein comprising the hoist arm.

The method comprises, if the second lower block sheave assemblies are connected to the lower block base, using the hoist reeving, pulling the first lower block sheave assemblies with the connected lower block base up towards the upper block assembly beyond the predetermined limit, thereby unloading the second lower block sheave assemblies, and disconnecting the unloaded second lower block sheave assemblies from the lower block base, thereby reducing the effective number of falls.

Alternatively or additionally, the method comprises, if the second lower block sheave assemblies are disconnected from the lower block base, connecting the second lower block sheave assemblies to the lower block base, in particular while the lower block base is suspended from the upper block assembly via the hoist reeving and the first lower block sheave assemblies positioned towards the upper block assembly beyond the predetermined limit, thereby increasing the effective number of falls. As noted elsewhere herein, the connecting of the second lower block sheave assemblies may be realized essentially by reversing the steps used for the earlier disconnection. In particular the second lower block sheave assemblies could be reconnected again when the first lower block sheave assemblies have been pulled up beyond the predetermined limit, so that the second lower block sheave assemblies are not immediately loaded when connected but can be loaded subsequently by lowering the lower block subsystem from the upper block assembly.

Such a method provides above mentioned advantages.

As explained elsewhere herein, to avoid straining, the first lower block sheave assemblies are preferably pulled up beyond the predetermined limit but not beyond a further predetermined limit, in particular due to a blocking of further upward movement of the first lower block sheave assemblies beyond the further predetermined limit by the upper block assembly.

A further aspect provides a use of a hoist block system, a hoisting assembly, and/or a vessel or barge as described herein, for offshore hoisting operations, in particular as part of offshore wind turbine installation operations.

Such a use provides above mentioned advantages.

It shall be appreciated that various aspects and options described herein may be variously combined, e.g. options described for the hoisting block system, hoisting assembly and/or vessel or barge may be correspondingly applied to the method and/or use, and vice versa.

### DETAILED DESCRIPTION

In the following, the invention will be explained further using examples of embodiments and drawings. The drawings are schematic and merely show examples. In the drawings, corresponding elements are provided with corresponding reference signs. In the drawings:

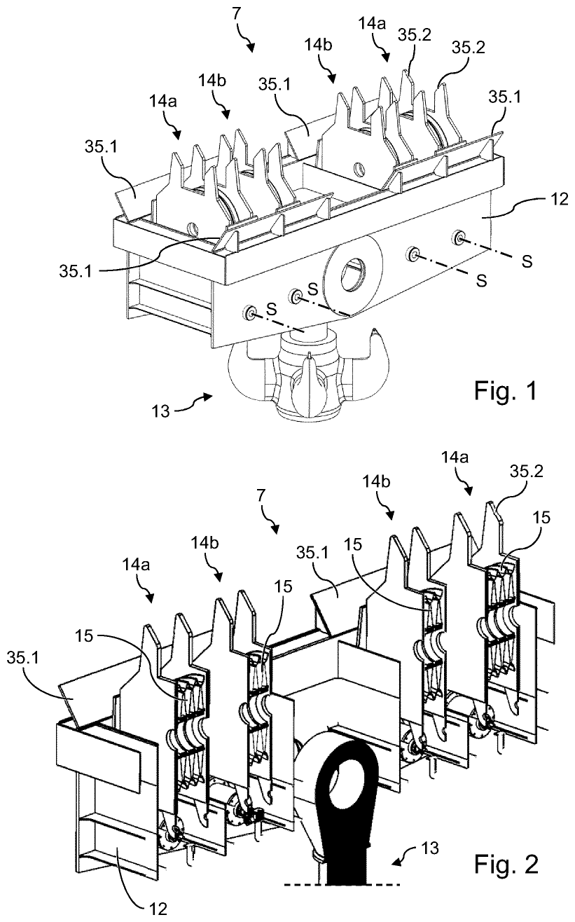

FIG. 1 shows a perspective view of a lower block subsystem of a hoist block system, wherein first and second lower block sheave assemblies are connected to a lower block base;

FIG. 2 shows a partly opened view of the lower block subsystem of FIG. 1;

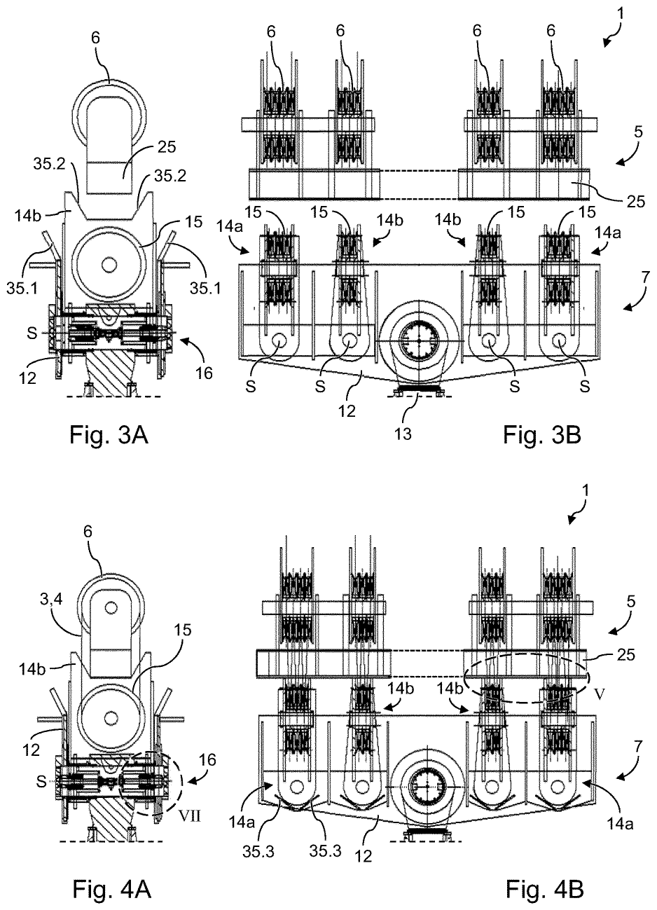

FIGS. 3A and 3B show a partly opened side view and partly opened front view, respectively, of a hoist block system including a lower block subsystem similar to that of FIGS. 1 and 2 and an upper block assembly;

FIGS. 4A and 4B show a partly opened side view and partly opened front view, respectively, of a hoist block system similar to that of FIGS. 3A-B, wherein the lower block subsystem has been pulled up so that the second lower block sheave assemblies contact the upper block assembly;

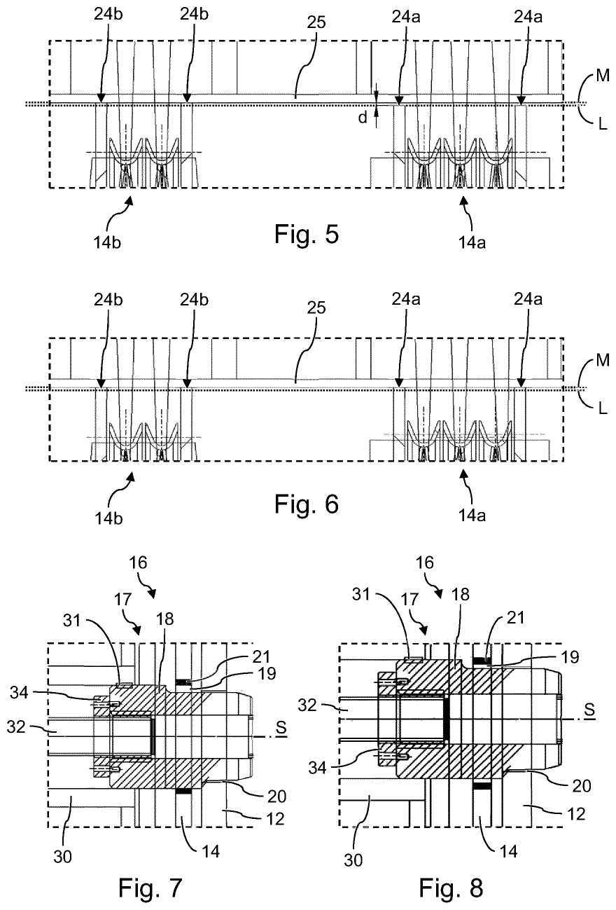

FIG. 5 shows a detail V of FIG. 4B;

FIG. 6 shows a detail corresponding to FIG. 5, wherein the lower block subsystem has been pulled up further;

FIG. 7 shows a detail VII of FIG. 4A, in particular showing part of a shaft assembly;

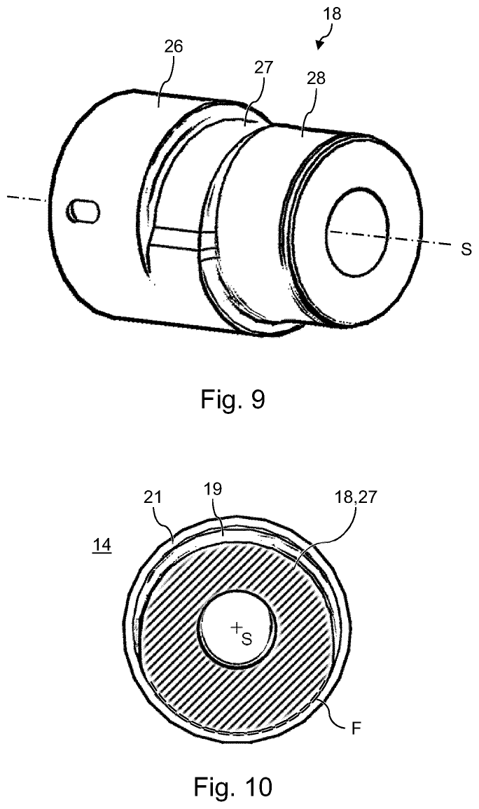

FIG. 8 shows a detail corresponding to FIG. 7, wherein the lower block subsystem has been pulled up further, essentially as in FIG. 6;

FIG. 9 shows a perspective view of a shaft element of the shaft assembly;

FIG. 10 shows a cross sectional axial view of a section of the shaft element of FIG. 9 in a shaft opening of a respective lower block sheave assembly;

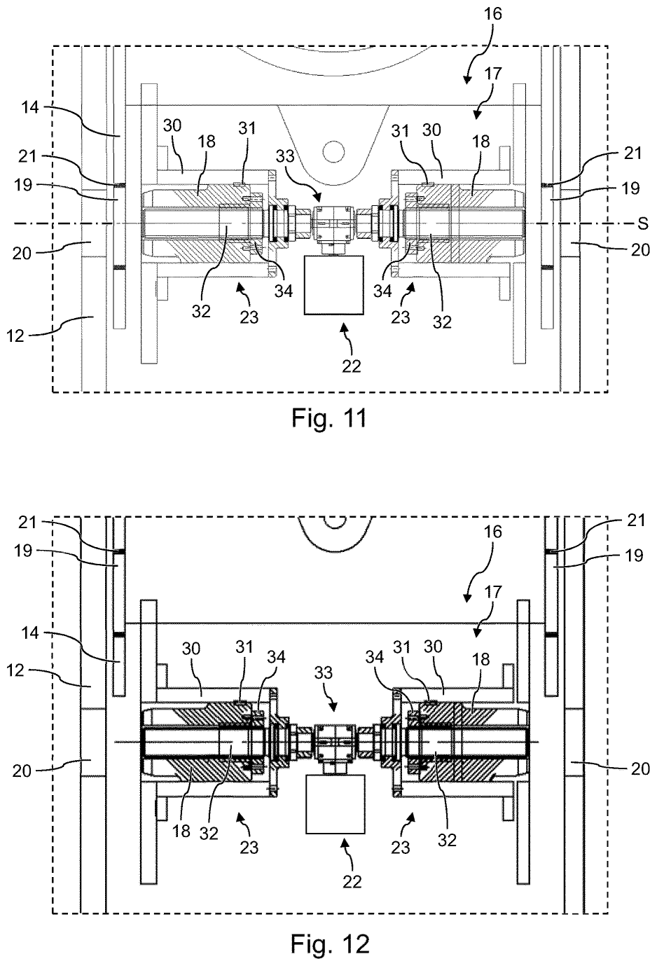

FIG. 11 shows a partly opened side view of the shaft assembly corresponding to FIG. 8, wherein the shaft assembly is in a retracted state;

FIG. 12 shows a view corresponding to FIG. 11, wherein the lower block base and connected first lower block sheave assemblies have been lowered from the upper block assembly while the second lower block sheave assemblies remain at the upper block assembly;

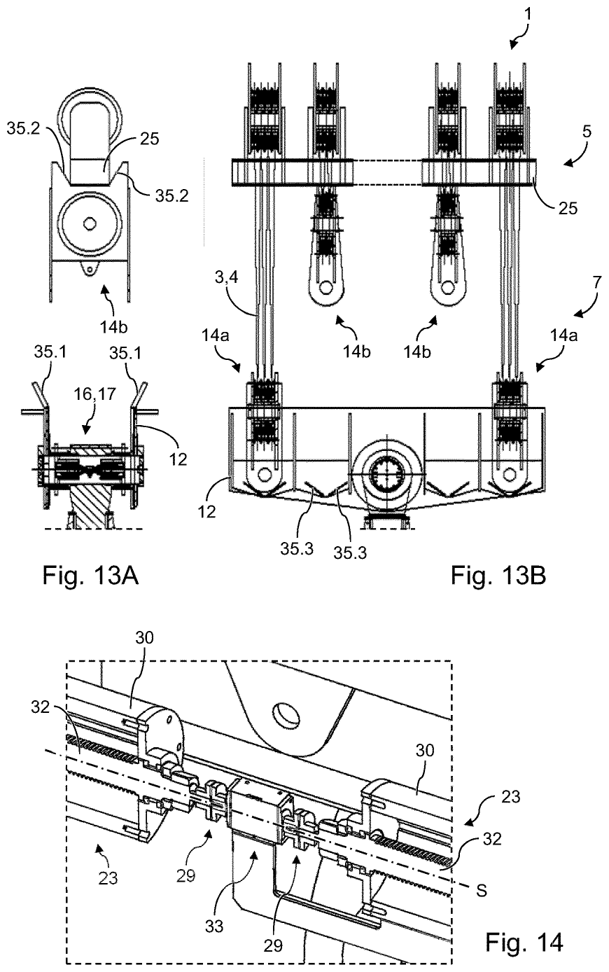

FIGS. 13A and 13B show views corresponding to FIGS. 4A and 4B, respectively, wherein the lower block base and connected first lower block sheave assemblies have been lowered further compared to FIG. 12;

FIG. 14 shows a partly opened perspective view of a detail of a shaft assembly similar to the shaft assembly of FIGS. 11 and 12;

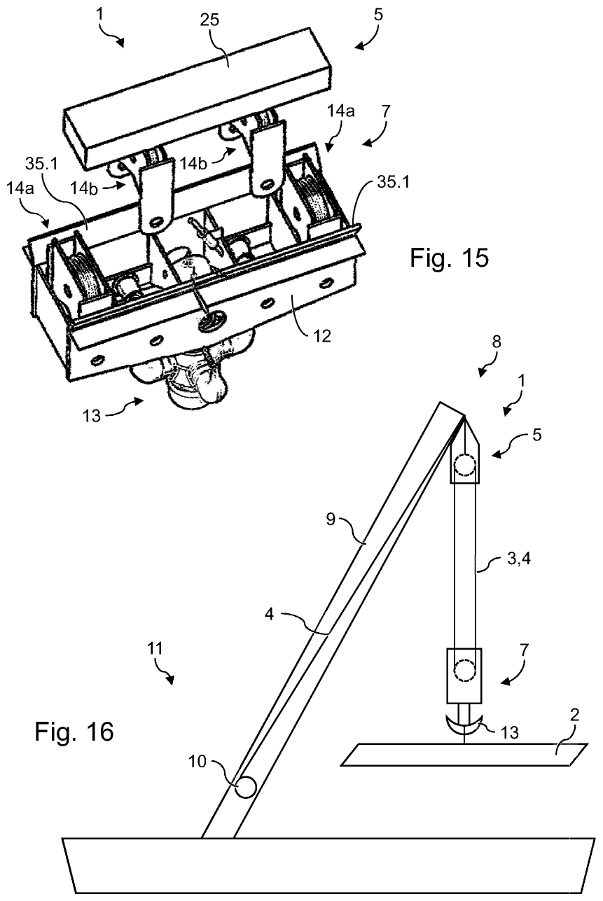

FIG. 15 shows a perspective view of a hoist block system similar to other shown examples, in a state corresponding to FIGS. 13A-B; and

FIG. 16 shows a side view of a vessel or barge with a hoist assembly comprising a hoist block system and with a hoist load suspended from the hoist block system.

The figures variously show a hoist block system 1 for hoisting a hoist load 2 selectively using fewer or more falls 3 of a hoist reeving 4. The hoist block system 1 comprises: an upper block assembly 5 comprising a plurality of interconnected upper block sheaves 6 configured to support the falls 3; and a lower block subsystem 7.

The figures also show a hoisting assembly 8 for hoisting a hoist load 2 selectively using fewer or more falls 3 of a hoist reeving 4, comprising the hoist block system 1 and the hoist reeving 4.

For the sake of clarity, such a hoist reeving 4 has been omitted from some of the figures. However, the skilled person having the benefit of the present disclosure will readily understand how a hoist reeving may be arranged in the shown examples, in particular with falls 3 extending substantially vertically between sheaves 6 of the upper block assembly 5 and sheaves 15 of the lower block subsystem 7 (sheaves 6 and 15 being indicated e.g. in FIGS. 3A-B).

With reference to FIG. 16, the hoisting assembly 8 may further comprise a hoist arm 9, such as a boom or an A-frame, wherein the hoist block system 1 may be suspended from the hoist arm 9, wherein the hoisting assembly 8 preferably comprises one or more winches 10 engaged with the hoist reeving 4 for adjusting the lengths of the falls 3. Here, a crane-type hoisting assembly 8 is shown, however it shall be appreciated that any type of hoisting assembly suitable for use with a hoist block system may be used. As shown in FIG. 16, a vessel or barge 11 may be provided with such a hoisting assembly 8, in particular for offshore hoisting operations.

The lower block subsystem 7 of the hoist block system 1 comprises: a lower block base 12 configured to have the hoist load suspended therefrom, e.g. using a hoisting hook 13 comprised by and/or connected to the lower block base 12; and a plurality of lower block sheave assemblies 14 each connectable to the lower block base 12 and each comprising a lower block sheave 15 suspendible from the upper block sheaves 6 by some of the falls 3. The plurality of lower block sheave assemblies 14 include one or more first lower block sheave assemblies 14a and one or more second lower block sheave assemblies 14b. Herein, reference sign 14 is used to generically refer to one or more of the lower block sheave assemblies, thus where applicable also to the first and second lower block sheave assemblies 14a and 14b.

The upper block assembly 5 is configured to block upward movement of the suspended second lower block sheave assemblies 14b towards the upper block assembly 5, while allowing upward movement of the suspended first lower block sheave assemblies 14a with the connected lower block base 12 towards the upper block assembly 5, when the first and second lower block sheave assemblies 14a, 14b are connected to the lower block base 12 and are pulled up towards the upper block assembly 5 by shortening of the falls 3, so that the second lower block sheave assemblies 14b can be unloaded by pulling the first lower block sheave assemblies 14a with the connected lower block base 12 up towards the upper block assembly 5 beyond a predetermined limit L.

In FIGS. 3A-B, it can be seen that the lower block subsystem 7 is still at a distance below the upper block assembly 5 with each of the lower block sheave assemblies 14 still connected to the lower block base 12, thus similar to FIGS. 1 and 2, e.g. having been used before with all of the available falls 3 (not shown in FIGS. 3A-B) for hoisting a relatively heavy hoist load. Subsequently, as explained in the following, the effective number of falls may be reduced, e.g. for hoisting lighter hoist loads faster and/or further. In FIG. 5, corresponding to FIGS. 4A-B, it can be seen that the first lower block sheave assemblies 14a, in particular upper block engagement faces 24a thereof, are pulled up to, but not yet beyond, such a predetermined limit L, while the second lower block sheave assemblies 14b, in particular upper block engagement faces 24b thereof, are already in contact with a blocking member 25 of the upper block assembly 5, here beyond the predetermined limit L. In FIG. 6, the first lower block sheave assemblies 14a with engagement face 24a have been pulled up even further, beyond the predetermined limit L, here to adjacent the blocking member 25 and possibly but not necessarily in contact therewith. Due to the earlier blocking of the upward movement of the second lower block sheave assemblies 14b at their engagement faces 24b by the blocking member 25, the second lower block sheave assemblies 14b are at this stage effectively unloaded, i.e. no longer supporting any weight of the lower block base 12.

The predetermined limit L can be at a relatively small distance d from a downward facing side of the blocking member 25, for example a distance of about 12 mm, which can already be sufficient to achieve the unloading, at least when the structures involved are sufficiently stiff so that the small distance d is not absorbed by deformation between the engagement faces 24 on the one hand and on the other hand the connection or connections between the lower block sheave assemblies and the lower block base 12, here at a shaft opening 19 as will be explained further herein.

As will be explained further herein, the unloaded second lower block sheave assemblies 14b are disconnectable from the lower block base 12, to thereby reduce the number of falls 3 by which the lower block base 12 is suspended from the upper block assembly 5, i.e. the effective number of falls In particular, the disconnected second lower block sheave assemblies 14b may remain at the upper block assembly 5 while not in use, as shown in FIGS. 13A-B, essentially being retained there by tension in the hoist reeving 4 as a result of the weight of the still suspended lower block base 12 and/or the first lower block sheave assemblies 14a and/or the hoist reeving 4. To subsequently increase the effective number of falls again, the procedure can essentially be reversed, i.e. the second lower block sheave assemblies 14b can be reconnected again when the first lower block sheave assemblies 14a have been pulled up beyond the predetermined limit L, so that the second lower block sheave assemblies 14b are not immediately loaded when connected but can be loaded subsequently by lowering the lower block subsystem 7 from the upper block assembly 5.

Such a hoist block system 1, hoisting assembly 8 and/or a vessel or barge 11 may be used for offshore hoisting operations, for example as part of offshore wind turbine installation operations.

Such a hoisting assembly 8 enables to adjust an effective number of falls 3 therein. For example, if the second lower block sheave assemblies 14b are connected to the lower block base 12, using the hoist reeving 4, the first lower block sheave assemblies 14a with the connected lower block base 12 may be pulled up towards the upper block assembly 5 beyond the predetermined limit L, thereby unloading the second lower block sheave assemblies 14b. The unloaded second lower block sheave assemblies 14b may then be disconnected from the lower block base 12, thereby reducing the effective number of falls 3.

Alternatively or additionally, if the second lower block sheave assemblies 14b are disconnected from the lower block base 12, the second lower block sheave assemblies 14b may be connected to the lower block base 12, in particular while the lower block base 12 is suspended from the upper block assembly 5 via the hoist reeving 4 and the first lower block sheave assemblies 14a positioned towards the upper block assembly 5 beyond the predetermined limit L, thereby increasing the effective number of falls 3.

In embodiments, including in the shown examples, the second lower block sheave assemblies 14b, and preferably the first lower block sheave assemblies 14a, are each connectable to the lower block base 12 so as to be rotatable with respect to the lower block base about a respective swivel axis S, here extending transverse to a main direction of the falls 3 and transverse to a rotation axis of the sheaves 6, 15. Alternatively, such a swivel axis could for example extend parallel to the rotation axis of the sheaves.

In embodiments, including in the shown examples, the hoist block system 1 comprises, for each of the second lower block sheave assemblies 14b, and preferably for one or more of the first lower block sheave assemblies 14a, a connecting mechanism, here a combined connecting and swiveling mechanism 16, configured to provide the connectability and disconnectability of the respective lower block sheave assembly 14 with respect to the lower block base 12, and here also configured to provide the rotatability of the respective lower block sheave assembly 14 with respect to the lower block base 12 about the respective swivel axis S when connected. Alternatively, such a swiveling function could be provided for by a separate mechanism, or could be omitted.

In embodiments, including in the shown examples, the connecting mechanism 16 is comprised by, in particular fixed to, the lower block base, although an associated bearing 21 may be fixed to the lower block sheave assembly 14 instead.

In embodiments, including in the shown examples, the connecting mechanism 16 comprises at least one shaft assembly 17 comprising one or more, here two, shaft elements 18, here aligned with the swivel axis S, the shaft assembly 17 being adjustable between a retracted state and an extended state. In the extended state, shown in FIGS. 7 and 8, the shaft elements 18 interconnect the respective lower block sheave assembly 14 with the lower block base 12. In the retracted state, shown in FIGS. 11 and 12, the shaft elements 18 release the respective lower block sheave assembly 14 with respect to the lower block base 12. In FIG. 12, it can be seen that the lower block base 12 has indeed been lowered with respect to the lower block sheave assembly 14.

In embodiments, including in the shown examples, in the extended state, each of the shaft elements 18 extends through a corresponding shaft opening 19 in the respective lower block sheave assembly 14 and/or through a corresponding shaft opening 20 in the lower block base 12, wherein, in the retracted state, the shaft element 18 is outside at least one of said shaft openings 19, 20, preferably at least outside the shaft opening 19 of the lower block sheave assembly 14. In the shown example, the shaft opening 19 of the lower block sheave assembly 14 can be positioned between the shaft opening 20 of the lower block base and the shaft assembly 17 which is here fixed to the lower block base 12. Thereby, the shaft element 18 can advantageously be connected to the lower block base 12 on both sides of the shaft opening 19 for a particularly strong and stable connection.

By comparing FIGS. 7 and 8, it can be seen that the shaft element 18 is supported on the lower block sheave assembly 14 via the bearing 21 when the lower block sheave assembly 14 is loaded (see FIG. 7) but not when the lower block sheave assembly 14 is unloaded (see FIG. 8). Thus, when unloaded, the shaft element 18 may be retracted from the shaft openings 19 and 20 substantially without friction or shock. Similarly, to reconnect the lower block sheave assembly 14, the shaft element 18 can be extended through the shaft openings 19 and 20 again while the lower block sheave assembly 14 can remain unloaded, only to be loaded again when the connection has been completed.

In embodiments, including in the shown examples, the upper block assembly 5 is configured to block upward movement of the suspended first lower block sheave assemblies 14a towards the upper block assembly 5 beyond a further predetermined limit M (see FIG. 6), the further predetermined limit M being closer to the upper block assembly 5 than the predetermined limit L, thus normally being at a higher level than the predetermined limit L. Straining of the second lower block sheave assemblies 14b during their disconnection can advantageously be prevented thereby, in particular without requiring highly precise active positioning of the first lower block sheave assemblies 14a. In the shown example, the further predetermined limit M corresponds to the downward facing side of the blocking member 25. The distance between the predetermined limit L and the further predetermined limit M, here corresponding to the distance d as indicated in FIG. 5, is here chosen in accordance with available play between the shaft elements 18 and corresponding shaft openings 19. In particular, in FIG. 8 it can be seen that the shaft element 18 has been made free from earlier contact (as seen in FIG. 7) with bearing 21 of shaft opening 19, so that a substantially strain free axial retraction of the shaft element 18 from the shaft opening 19 is made possible. In the shown examples, the distance d between the limits L and M corresponds to about half of the available play in the corresponding direction, i.e. normally the height direction, so that the shaft element 18 is seen in FIG. 8 approximately vertically centered within the bearing 21. Although the described configuration involving the further predetermined limit M is preferred, as an alternative the aforementioned play could be enlarged, e.g. so that position control by winches 10 would be sufficient to maintain a substantially strain free arrangement.

In embodiments, including in the shown examples, the shaft element 18 and the corresponding shaft opening 19 of the lower block sheave assembly 14 are dimensioned and/or shaped to provide play therebetween when the shaft assembly 17 is in the extended state, while also providing a substantially fitting interface F therebetween (indicated in FIG. 10 by a double dashed line) along parts of the circumferences of the shaft element 18 and shaft opening 19 arranged to transmit loads therebetween during use.

In embodiments, including in the shown examples, a section 27 of the shaft element 18 extending in the shaft opening 19 of the lower block sheave assembly 14 when the shaft assembly 17 is in the extended state, and said shaft opening 19 itself, have mutually different cross sectional shapes, in particular with mutually corresponding radii, here from the swivel axis S, only along a limited circumferential part including a part, here a bottom part, configured to provide a load bearing interface F, as can be seen in FIG. 10. It shall be appreciated that if a similar shaft assembly were fixed to the lower block sheave assembly 14 instead of to the lower block base 12, a top part rather than a bottom part would normally be configured to provide such a load bearing interface.

In FIG. 9, it can be seen that the relevant section 27 is here an intermediate section, extending between a proximal section 26 providing a connection to other parts of the shaft assembly 18 and a distal section 28 extending in the shaft opening 20 of the lower block base 12 when connected. A smaller radius of the radii of the intermediate section 27 here corresponds to an overall radius of the distal section 28, while a larger radius of the radii of the lower intermediate section 27 here corresponds to an overall radius of the proximal section 26.

In embodiments, including in the shown examples, the shaft opening 19 in the lower block sheave assembly 14 is provided with a bearing 21 to reduce rotational friction between said shaft opening 19 and the shaft element 18, in particular about the swivel axis S, when the shaft assembly 17 is in the extended state. Alternatively or additionally, such a bearing could be arranged on a section 27 of the shaft element 18 extending in the shaft opening 19 of the lower block sheave assembly 14 when the shaft assembly 17 is in the extended state. The bearing 21 is here primarily intended to promote smooth and durable swiveling about the swiveling axis S when the lower block sheave assembly 14 is connected to the lower block base 12 and is loaded by the weight of the lower block base 12, and possibly further by a load suspended from the lower block base 12.

In embodiments, including in the shown examples, the hoist block system 1 comprises at least one motor 22 and/or gear box 33 coupled, at least couplable, to the shaft element 18 for adjusting the shaft assembly 17 between the retracted state and the extended state by driving of the motor 22 and/or gear box 33. The motor 22 and/or gear box 33 is preferably fixated to the lower block base 12, for example via a shell 30 as shown in FIG. 14.

In embodiments, including in the shown examples, multiple, here two, of the shaft elements 18 are coupled to a same motor 22 and/or gear box 33 of the at least one motor 22 and/or gear box 33, in particular for synchronized adjustment of the multiple shaft elements 18 between the retracted state and the extended state, wherein in particular said multiple shaft elements 18 are comprised by a same shaft assembly 17 and/or are for connection with a same lower block sheave assembly 14 and/or are aligned with a same axis such as a swivel axis S. Thereto, the gear box 33 may comprise one or more bevel gears, in particular to provide a right-angled transmission of which an input shaft extends at a right angle to two output shafts connecting to the shaft elements 18, as shown in FIGS. 11 and 12. Although a gear box 33 is shown here, alternatively the shaft elements 18 could be driven directly, i.e. without intermediate gearing, e.g. by a motor and/or by a manually operated tool.

In embodiments, including in the shown examples, the motor 22 and/or gear box 33 is coupled to the shaft element 18 via a conversion mechanism 23 configured to convert a rotation of an output shaft of the motor 22 and/or gear box 33 to an axial translation of the shaft element 18, here along the swivel axis S. The conversion mechanism 23 here comprises a threaded interface between the shaft element 18 and a threaded driving bolt 32 fixed to an output shaft of the motor 22. In the shown example, a nut 34 is fixed to the shaft element 18 to provide the threaded interface with the threaded driving bolt 32. Alternatively, the shaft element 18 itself could have internal threading. The conversion mechanism 23 here further comprises an axial guiding structure 31 between the shaft element 18 and a shell 30 in which at least part of the shaft element 18 is received, the axial guiding structure 31 being configured to enable movement between the shaft element 18 and the shell 30 along the swiveling axis S, while inhibiting rotational movement therebetween about the swiveling axis S. The shell 30 is here fixed to the lower block base 12.

More generally, various guiding structures 35.1, 35.2, 35.3 (also collectively indicated herein as 35), in particular centering structures, are preferably provided in the hoist block system 1 to guide mutual positioning of mutually movable elements. In the shown examples: guiding structures 35.2 guide the lower block sheave assemblies 14 with respect to the blocking member 25 of the upper block assembly 5; and guiding structures 35.1 and 35.3 guide the lower block sheave assemblies 14 with respect to the lower block base 12 and/or the shaft assembly 17. Such guiding structures 35 may in particular comprise pairs of guiding surfaces extending at an angle to each other to define a guiding space or guiding path tapered towards a desired position of an element to be guided. For clarity of the drawings, not all such guiding structures 35 have been provided with reference signs in all of the figures, whereas in view of the indicated guiding structures 35 and the present description it shall be understood where further such guiding structures are visible in the drawings. In FIG. 3B, guiding structures 35.3 as shown in FIGS. 4B and 13B have been omitted, illustrating a possible variation. In FIG. 15, guiding structures 35.2 as shown in FIGS. 1, 2, 3A, 4A, 13A have been omitted, illustrating a possible variation. In FIGS. 1 and 2, guiding structures 35.2 are shaped somewhat differently compared to corresponding guiding structures 35.2 in FIGS. 3A, 4A, 13A, although their function is essentially the same, illustrating a possible variation.

As shown in FIG. 14, flexible couplings 29 are here provided between the motor 22 and/or gear box 33 on the one hand and the conversion mechanisms 23 on the other hand, to resolve possible alignment imperfections.

Although the invention has been explained herein using examples of embodiments and drawings, these do not limit the scope of the invention as defined by the claims. Many variations, combinations and extensions are possible, as will be appreciated by the skilled person having the benefit of the present disclosure. For example, a hoisting assembly may be used on land and/or be provided on a land-based vehicle. All such variants are included within the scope of the invention as defined by the claims.

### LIST OF REFERENCE SIGNS

1. Hoist block system
2. Hoist load
3. Fall
4. Hoist reeving
5. Upper block assembly
6. Upper block sheave
7. Lower block subsystem
8. Hoisting assembly
9. Hoist arm
10. Winch
11. Vessel or barge
12. Lower block base
13. Hoisting hook
14. Lower block sheave assembly
14a. First lower block sheave assembly
14b. Second lower block sheave assembly
15. Lower block sheave
16. Combined connecting and swiveling mechanism
17. Shaft assembly
18. Shaft element
19. Shaft opening in lower block sheave assembly
20. Shaft opening in lower block base
21. Bearing
22. Motor
23. Conversion mechanism
24a. Upper block engagement face of first lower block sheave assembly
24b. Upper block engagement face of second lower block sheave assembly
25. Blocking member
26. Proximal section of shaft element
27. Intermediate section of shaft element
28. Distal section of shaft element
29. Flexible coupling
30. Shell
31. Axial guiding structure
32. Threaded driving bolt
33. Gear box
34. Nut
35. Guiding structure (includes 35.1, 35.2, 35.3)
d. Distance between blocking member and predetermined limit
F. Interface
L. Predetermined limit
M. Further predetermined limit
S. Swivel axis

1. A hoist block system for hoisting a hoist load selectively using fewer or more falls of a hoist reeving, the hoist block system comprising:
an upper block assembly comprising a plurality of interconnected upper block sheaves configured to support the falls; and
a lower block subsystem,
wherein the lower block subsystem comprises:
a lower block base configured to have the hoist load suspended therefrom; and
a plurality of lower block sheave assemblies each connectable to the lower block base and each comprising a lower block sheave suspendible from the upper block sheaves by some of the falls, wherein the plurality of lower block sheave assemblies include one or more first lower block sheave assemblies and one or more second lower block sheave assemblies,
wherein the upper block assembly is configured to block upward movement of the suspended second lower block sheave assemblies towards the upper block assembly, while allowing upward movement of the suspended first lower block sheave assemblies with the connected lower block base towards the upper block assembly, when the first and second lower block sheave assemblies are connected to the lower block base and are pulled up towards the upper block assembly by shortening of the falls, so that the second lower block sheave assemblies can be unloaded by pulling the first lower block sheave assemblies with the connected lower block base up towards the upper block assembly beyond a predetermined limit, wherein the unloaded second lower block sheave assemblies are disconnectable from the lower block base, to thereby reduce the number of falls by which the lower block base is suspended from the upper block assembly.

2. The hoist block system according to claim 1, comprising, for each of the second lower block sheave assemblies, a connecting mechanism, configured to provide the connectability and disconnectability of the respective lower block sheave assembly with respect to the lower block base.

3. The hoist block system according to claim 2, wherein the connecting mechanism is further configured to provide rotatability of the respective lower block sheave assembly with respect to the lower block base about a respective swivel axis when connected.

4. The hoist block system according to claim 2, wherein the connecting mechanism is fixed to the lower block base.

5. The hoist block system according to claim 2, wherein the connecting mechanism comprises at least one shaft assembly comprising one or more shaft elements, the shaft assembly being adjustable between a retracted state and an extended state, wherein in the extended state the shaft elements interconnect the respective lower block sheave assembly with the lower block base, wherein in the retracted state the shaft elements release the respective lower block sheave assembly with respect to the lower block base.

6. The hoist block system according to claim 5, wherein, in the extended state, each of the shaft elements extends through a corresponding shaft opening in the respective lower block sheave assembly and/or through a corresponding shaft opening in the lower block base, wherein, in the retracted state, the shaft element is outside at least one of said shaft openings.

7. The hoist block system according to claim 6, wherein the shaft element and the corresponding shaft opening of the lower block sheave assembly are dimensioned and/or shaped to provide play therebetween when the shaft assembly is in the extended state, while also providing a substantially fitting interface therebetween along parts of the circumferences of the shaft element and shaft opening arranged to transmit loads therebetween during use.

8. The hoist block system according to claim 7, wherein a section of the shaft element extending in the shaft opening of the lower block sheave assembly when the shaft assembly is in the extended state, and said shaft opening itself, have mutually different cross sectional shapes.

9. The hoist block system according to claim 6, wherein a section of the shaft element extending in the shaft opening of the lower block sheave assembly when the shaft assembly is in the extended state, and/or said shaft opening itself, is provided with a bearing to reduce rotational friction between said shaft opening and the shaft element when the shaft assembly is in the extended state.

10. The hoist block system according to claim 5, comprising at least one motor and/or gear box coupled, at least couplable, to the shaft element for adjusting the shaft assembly between the retracted state and the extended state by driving of the motor and/or gear box.

11. The hoist block system according to claim 10, wherein multiple of the shaft elements are coupled to a same motor and/or gear box of the at least one motor and/or gear box, for synchronized adjustment of the multiple shaft elements between the retracted state and the extended state, wherein said multiple shaft elements are comprised by a same shaft assembly and/or are for connection with a same lower block sheave assembly and/or are aligned with a same swivel axis.

12. The hoist block system according to claim 10, wherein the motor and/or gear box is coupled to the shaft element via a conversion mechanism configured to convert a rotation of an output shaft of the motor and/or gear box to an axial translation of the shaft element.

13. The hoist block system according to claim 1, wherein the upper block assembly is configured to block upward movement of the suspended first lower block sheave assemblies towards the upper block assembly beyond a further predetermined limit closer to the upper block assembly than the predetermined limit, so as to prevent straining of the second lower block sheave assemblies during their disconnection.

14. A hoisting assembly for hoisting a hoist load selectively using fewer or more falls of a hoist reeving, comprising the hoist block system according to any of the claim 1 and the hoist reeving.

15. The hoisting assembly according to claim 14, comprising a hoist arm, wherein the hoist block system is suspended from the hoist arm, wherein the hoisting assembly comprises one or more winches engaged with the hoist reeving for adjusting the lengths of the falls.

16. A vessel or barge provided with the hoisting assembly according to claim 14.

17. A method of adjusting an effective number of falls in a hoisting assembly, the method comprising:
providing the hoisting assembly according to claim 15;
if the second lower block sheave assemblies are connected to the lower block base, using the hoist reeving, pulling the first lower block sheave assemblies with the connected lower block base up towards the upper block assembly beyond the predetermined limit, thereby unloading the second lower block sheave assemblies, and disconnecting the unloaded second lower block sheave assemblies from the lower block base, thereby reducing the effective number of falls; and/or
if the second lower block sheave assemblies are disconnected from the lower block base, connecting the second lower block sheave assemblies to the lower block base, while the lower block base is suspended from the upper block assembly via the hoist reeving and the first lower block sheave assemblies positioned towards the upper block assembly beyond the predetermined limit, thereby increasing the effective number of falls.

18. (canceled)

19. The hoist block system according to claim 2, wherein one or more of the first lower block sheave assemblies is configured for connectability and disconnectability with the lower block base.

20. The hoist block system according to claim 6, wherein said at least one of said shaft openings, which the shaft element is outside of in the retracted state, includes the shaft opening of the lower block sheave assembly.

21. The hoist block system according to claim 8, wherein the cross section shapes have mutually corresponding radii only along a limited circumferential part including a part configured to provide a load bearing interface.
